(19) United States
(12) Patent Application Publication
(10) Pub. No.: US 2002/0185760 A1
(43) Pub. Date: Dec. 12, 2002

(54) Disk molding apparatus and disk substrate manufacturing method

(75) Inventor: Keiji Suga, Tsurugashima-shi (JP)

Correspondence Address: SUGHRUE MION, PLLC, 2100 PENNSYLVANIA AVENUE, N.W., WASHINGTON, DC, 20037, US

(73) Assignee: PIONEER CORPORATION

(21) Appl. No.: 10/164,379

(22) Filed: Jun. 10, 2002

(30) Foreign Application Priority Data
Jun. 12, 2001 (JP) P2001-176718

(51) Int. Cl. B29D 11/00

(52) U.S. Cl. 264/1.33; 425/810; 425/150; 425/553; 264/154

(57) ABSTRACT

A disk molding apparatus is provided with: a fixed die; a movable die that presses a molten resin material filling a cavity formed by the fixed die and the movable die to mold a disk and punches a central part of the disk to bore a hole; a control device that controls a reciprocation of the movable die in a thickness direction of the disk; and wherein a projection for punching the central part of the disk is formed on a mirror plate of the movable die integrally with the movable die.

### BACKGROUND OF THE INVENTION

1. Field of the Invention

The present invention relates to a disk molding device for molding disks for use in information recording, such as compact disks (CDs) and digital versatile disks (DVDs).

2. Description of the Related Art

FIG. 7 shows a typical section of the essential part of a conventional disk (e.g. DVD) molding apparatus. As illustrated, the conventional disk molding apparatus is provided with a fixed side housing 45 and a movable side housing 46. The fixed side housing 45 is provided with a fixed die 52, and the movable side housing 46 is provided with a movable die 53. When the dies are closed, a cavity 51 for molding a disk is formed between the fixed die 52 and the movable die 53. Further, on the cavity 51 side of each of the fixed die 52 and the movable die 53, there is a mirror plate formed by mirror-grinding a surface.

A sprue 54 for ejecting a molten resin material for molding a disk is built into a central part of the fixed die 52 via a sprue bush 55. Further, a stamper 56 for transferring and molding signal pits of the disk is fixed with stamper keep plates 57 on the cavity 51 side of the fixed die 52.

On the other hand, in a central part of the movable die 53, there is slidably provided a movable punch 58 for punching a central part of a molded disk and thereby boring a hole. To this movable punch 58 is linked a punch unit 59, and the movable punch 58 moves back and forth along with reciprocations of a piston provided within the punch unit 59.

Molten resin material heated and melted within a heating cylinder 60 and ejected from a nozzle 61 in such a configuration is injected by the sprue 54 into the cavity 51, which is filled therewith and, as concaves and convexes impressed on the stamper 56 are transferred onto the molten resin material, a disk is molded. After that, driven by the punch unit 59, the movable punch 58 is protruded toward the cavity 51 to punch the central part of the molded disk and, after it is cooled, dies are opened to take out the disk substrate.

FIG. 8, an enlarged view of part “A” surrounded by broken lines in FIG. 7, illustrates how the central part of the molded disk is punched. In order for the movable punch 58 to punch the central part of the molded disk, the movable punch 58 has to be driven forward beyond the thickness of the part (gate) (hereinafter referred to as the mold aperture) to be punched with the movable punch 58. For instance in FIG. 8 the mold aperture is supposed to be about 0.53 mm, and in order to punch the central part of the molded disk in this case, the movable punch 58 is required to move farther forward by about 0.1 mm. Thus, the required advance of the movable punch 58 is about 0.63 mm.

Thus, whereas the central part of the molded disk is punched by sliding the movable punch 58 in the conventional disk molding apparatus, the presence of the movable punch 58 and of the punch unit 59 to slide it necessitates a very great length Z1 of the movable side housing 46, resulting in a inconvenience that reducing the overall size of the disk molding apparatus is strictly limited. Furthermore, because resin solidified in the sprue 54 has to be discarded every time a disk substrate is produced, it is preferable to minimize the length of the sprue 54 and thereby to reduce the length Z2 of the fixed side housing 45, but reducing only the length Z2 of the fixed side housing 45 gives rise to another inconvenience of a thermal imbalance between the fixed side housing 45 and the movable side housing 46.

Moreover, as the presence of the movable punch 58 and of the punch unit 59 invites an enlarged hollow part in the movable side housing 46, resulting in the inconvenience of insufficient rigidity and increased flexure of the die.

Furthermore, as the movable punch 58 slides, it is liable to become eccentric and susceptible to the generation of many burrs (filamentary thorns of resin around the punched hole in the molded disk). There is still another inconvenience that the sliding of the movable punch 58 readily gives rise to scoring, and metal powder resulting from this scoring invites a inconvenience of the metal powder sticking to the disk (hereinafter referred to as contamination).

In addition, in the conventional disk molding apparatus, as the disk substrate thickness of a DVD, for instance, is prescribed to be 0.6 mm, the molten resin material injected into the cavity 51 by the sprue 54 permeates into every corner of (fills) the cavity 51, but if in the future an extremely thin disk substrate (e.g. a disk substrate of 0.3 mm or less) is to be produced, there will arise a inconvenience that the thinness of the disk substrate prevents the molten resin material injected into the cavity 51 by the sprue 54 from permeating into every corner of the cavity 51.

### SUMMARY OF THE INVENTION

It is therefore an object of the present invention to provide a disk molding apparatus and a disk substrate manufacturing method that allows to reduce the size of the movable side housing, to prevent eccentricity, burrs, scoring and contamination from occurring, and to easily and efficiently product extremely thin disk substrates.

The above object of the present invention can be achieved by a disk molding apparatus provided with: a fixed die; a movable die that presses a molten resin material filling a cavity formed by the fixed die and the movable die to mold a disk and punches a central part of the disk to bore a hole; a control device that controls a reciprocation of the movable die in a thickness direction of the disk; and wherein a projection for punching the central part of the disk is formed on a mirror plate of the movable die integrally with the movable die.

According to the present invention, it is possible to dispense with a drive unit such as a cylinder for sliding only a projection, resulting in a substantial reduction in the dimensions of the movable side housing. This leads to the advantage that the dimensions of the fixed side housing and the movable side housing can be reduced while maintaining the thermal balance between them, and the overall size of the disk molding apparatus can be reduced eventually.

As the reduced size of the movable side housing makes possible a reduction in the hollow part, the rigidity can be increased, and the flexure of the dies can be restrained. Also, the number of die plates can be reduced to enhance dimensional accuracy.

As the projection is formed integrally on the mirror plate of the movable die and does not slide itself, eccentricity, scoring, burrs and contamination can be prevented.

Moreover, as molten resin material, after a cavity is filled with it, is pressed with the movable die to be molded into a disk, whose central part is punched with the projection to bore a hole, an extremely thin disk substrate (e.g. 0.3 mm or less in thickness) can be produced easily and efficiently.

In one aspect of the disk molding apparatus of the present invention, a gap between the fixed die and the movable die in a state that dies are closed, is at least greater than length of the projection and great enough to permit the cavity to be filled with the molten resin material.

According to this aspect, it is possible to fill the cavity with the molten resin material without obstructing the flow of the molten resin material.

In another aspect of the disk molding apparatus of the present invention, a gap between the fixed die and the movable die in a state that dies are closed, is not less than 0.1 mm but not more than 5 mm.

According to this aspect, it is possible to fill the cavity with the molten resin material without obstructing the flow of the molten resin material.

In further aspect of the disk molding apparatus of the present invention, length of the projection is greater than thickness of the disk.

According to this aspect, the projection can reliably punch the central part of the disk.

The above object of the present invention can be achieved by a disk molding apparatus provided with: a fixed die; a movable die that presses a molten resin material mounted on a mirror plate of the fixed die to mold a disk and punches a central part of the disk to bore a hole; a control device that controls a reciprocation of the movable die in a thickness direction of the disk; and wherein a projection for boring the hole in the central part of the disk is formed on the mirror plate of the fixed die integrally with the fixed die.

According to the present invention, it is possible to dispense with a drive unit such as a cylinder for sliding only a projection, resulting in a substantial reduction in the dimensions of the movable side housing. This leads to the advantage that the dimensions of the fixed side housing and the movable side housing can be reduced while maintaining the thermal balance between them, and the overall size of the disk molding apparatus can be reduced eventually.

As the reduced size of the movable side housing makes possible a reduction in the hollow part, the rigidity can be increased, and the flexure of the dies can be restrained. Also, the number of die plates can be reduced to enhance dimensional accuracy.

As the projection is formed integrally on the mirror plate of the fixed die and does not slide itself, eccentricity, scoring, burrs and contamination can be prevented.

Moreover, as molten resin material is pressed with the movable die to be molded a disk, whose central part is punched with the projection to bore a hole, an extremely thin disk substrate (e.g. 0.3 mm or less in thickness) can be produced easily and efficiently.

Furthermore, an eccentricity-free disk substrate can be produced because it is unaffected by gravity.

In one aspect of the disk molding apparatus of the present invention, length of the projection is greater than thickness of the disk.

According to this aspect, the projection can reliably punch the central part of the disk.

The above object of the present invention can be achieved by a disk substrate manufacturing method provided with: a process of ejecting a molten resin material into a cavity formed by a fixed die and a movable die; and a process of molding a disk by pressing the molten resin material filling the cavity, with the movable die, and manufacturing a disk substrate in which a hole is to be bored by punching a central part of the disk with a projection is integrally formed on a mirror plate of the movable die.

According to the present invention, a disk substrate can be manufactured while preventing eccentricity, scoring, burrs and contamination from occurring.

In one aspect of the disk substrate manufacturing method of the present invention, during a period from the ejecting the molten resin material into the cavity until the molding the disk by pressing the molten resin material filling the cavity, the fixed die and the movable die are maintained at a prescribed temperature high enough not to let the molten resin material solidify and, after the disk is molded, the fixed die and the movable die are cooled to a prescribed temperature low enough for the molten resin material to solidify.

According to this aspect, the molten resin material can be prevented from solidifying and can permeate into every corner of the cavity even if the gap between the fixed die and the movable die is far greater than according to the prior art.

### BRIEF DESCRIPTION OF THE DRAWINGS

FIG. 1 shows a typical section of an essential part of a disk molding apparatus in a practical embodiment of the present invention;

FIG. 2A shows a fixed die 3 and a movable die 4 extracted from FIG. 1;

FIG. 2B shows, the movable die 4 viewed in a direction of a thick arrow in FIG. 2A;

FIG. 3 is a flow chart of a disk substrate manufacturing process;

FIGS. 4A and 4B show how a disk molding apparatus 100 operates when molten resin material is pressed by the movable die 4 to mold a disk;

FIG. 5 shows an enlarged view of part “B” surrounded by broken lines in FIG. 4B;

FIG. 6 illustrates another disk molding apparatus of the embodiment than the disk molding apparatus 100;

FIG. 7 shows a typical section of an essential part of a conventional disk (e.g. DVD) molding apparatus; and

FIG. 8 shows an enlarged view of part “A” surrounded by broken lines in FIG. 7.

### DETAILED DESCRIPTION OF THE PREFERRED EMBODIMENTS

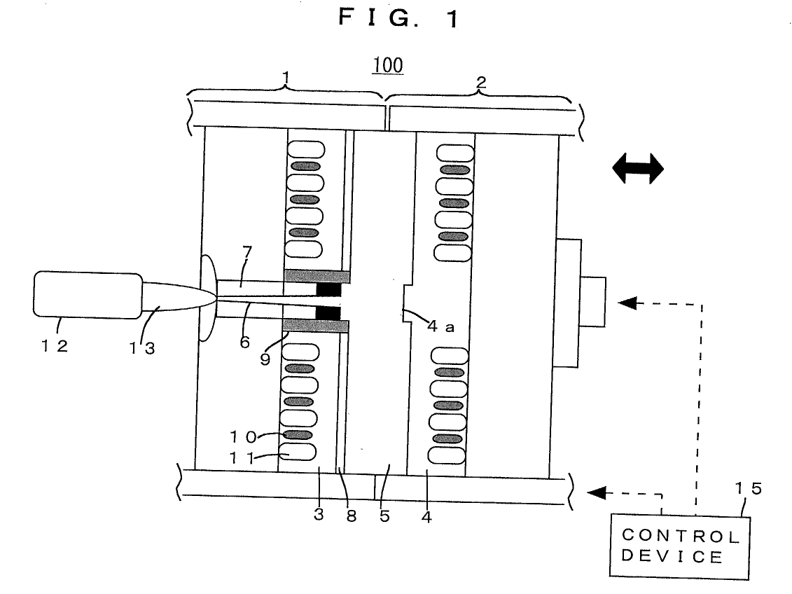

Preferred embodiments of the present invention will be described in detail below with reference to accompanying drawings. FIG. 1 shows a typical section of the essential part of a disk molding apparatus in a practical embodiment of the present invention. As illustrated in FIG. 1, a disk molding apparatus 100 is provided with a fixed side housing 1 and a movable side housing 2, and this example is in a state wherein dies are closed. The fixed side housing 1 is provided with a fixed die 3, and the movable side housing 2, with a movable die 4, and when the dies are closed, a cavity 5 for molding a disk is formed between the fixed die 3 and the movable die 4. In addition, the disk molding apparatus 100 in a practical embodiment of the present invention has functions of a horizontal injection molder.

The movable side housing 2 can reciprocate in the directions of the double-headed arrow at instructions from a control device 15, and the dies are thereby opened or closed. Moreover, the control device 15 controls a reciprocation of the movable die 4 in a thickness direction of a disk. Therefore, the movable die 4 can move within the movable side housing 2 in the directions of the arrow, and thereby press molten resin material which, to be described in more detail later, fills the cavity 5.

On each of the fixed die 3 and the movable die 4 is formed a mirror plate whose cavity 5 side is mirror-ground. A sprue 6 for injecting molten resin material (e.g. polycarbonate) into the cavity 5, is built into the central part of the fixed die 3 via a sprue bush 7. A stamper 8 for transferring and molding signal pits of the disk is fixed with stamper keep plates 9 on the cavity 5 side of the fixed die 3.

The fixed die 3 is provided with a plurality of heaters 10 and a plurality of cooling water channels 11. The heaters 10 are intended to heat the fixed die 3, until the cavity 5 is filled with the molten resin material, to a temperature at which the molten resin material is not solidified (e.g. at a glassy transition temperature Tg: 146° C., or higher). On the other hand, the cooling water channels 11 are provided to cool, when the molten resin material is to be solidified, the fixed die 3 heated by the heaters 10, and cooling water of, for instance, 100° C. is circulating in the cooling water channels 11 all the time.

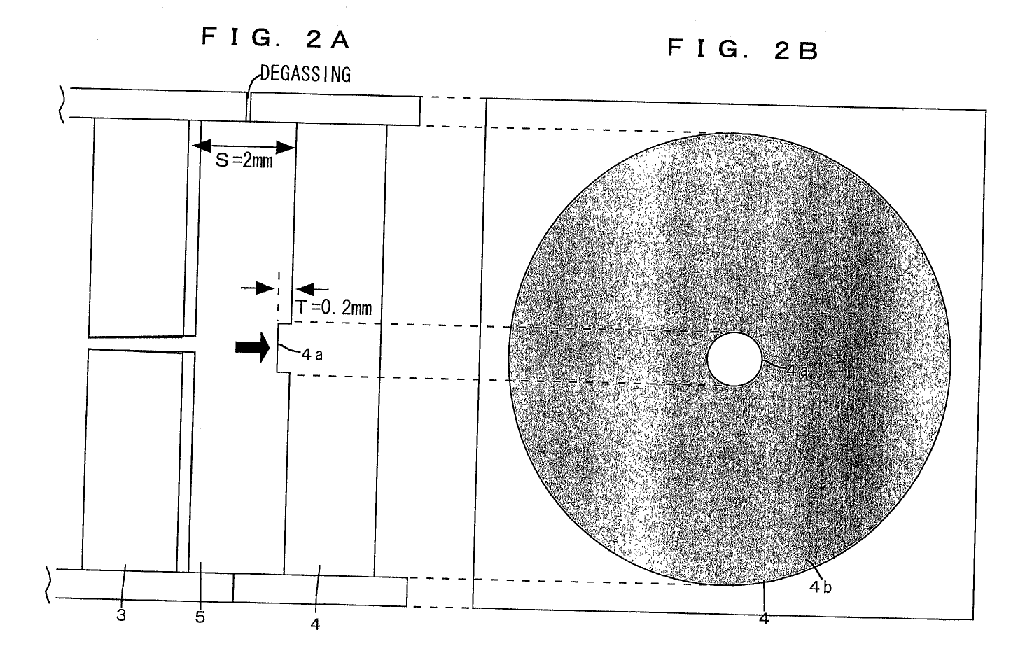

On the other hand, a fixed punch 4a, integrated with the movable die 4, as a projection for punching the central part of the disk, is formed on the mirror plate in the central part of the movable die 4. FIG. 2A shows the fixed die 3 and the movable die 4 extracted from FIG. 1. In the example of FIG. 2A, while the length T of the fixed punch 4a is prescribed to be about 0.2 mm, the gap S between the fixed die 3 and the movable die 4 in a state that dies are closed is prescribed to be about 2 mm. FIG. 2B shows the movable die 4 viewed in the direction of the thick arrow in FIG. 2A. In the central part of the mirror plate 4b of the movable die 4, a round fixed punch 4a is formed.

The length T of the fixed punch 4a is set to match the thickness of the disk substrate to be produced. The reason why the length T of the fixed punch 4a is prescribed to be about 0.2 mm in the case of FIG. 2A is that the production of a disk substrate of about 0.1 mm is intended. Thus, in order to punch the central part of the disk, it is necessary for the punch to move forward by approximately 0.1 mm more than the about 0.1 mm thickness of the disk substrate.

In this way, this integral formation of the fixed punch 4a for punching the central part of the disk with the movable die 4 dispenses with the movable punch, which is necessary for punching the central part of the disk according to the prior art.

Furthermore, the gap S between the fixed die 3 and the movable die 4 in a state that dies are closed can be set sufficiently wide to enable the cavity 5 to be filled with molten resin material with the length T of the fixed punch 4a taken into consideration, and preferably should be within a range of, for instance, 0.1 mm to 5 mm.

In addition, as shown in FIG. 1, the movable die 4 is also equipped with heaters 10 and cooling water channels 11 as the fixed die 3 is, and they heat and cool the movable die 4, respectively.

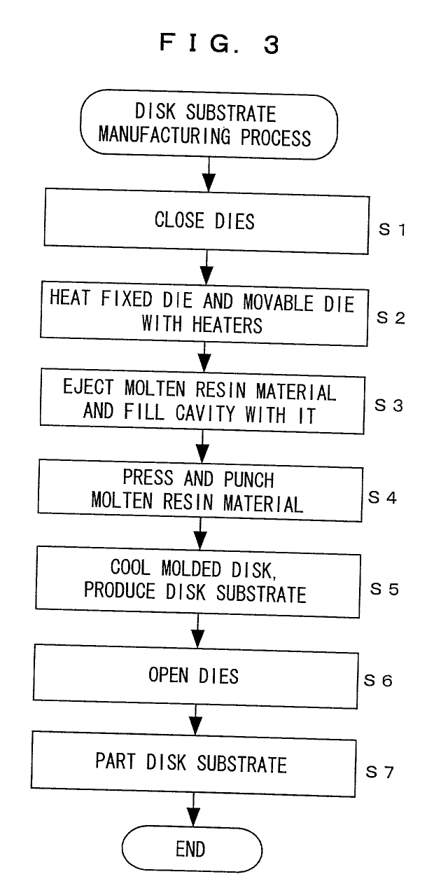

Next will be described the molding of a disk by the disk molding apparatus 100 configured as explained above. FIG. 3 is a flow chart of the disk substrate manufacturing process.

First, the movable side housing 2 is shifted toward the fixed side housing 1 by the control device 15 to close the dies (step S1). The gap S between the fixed die 3 and the movable die 4 is set to be about 2 mm as stated above. Then, the source of power supply to the heaters 10 is turned on, and the fixed die 3 and the movable die 4 are uniformly heated by the plurality of the heaters 10 to a temperature high enough not to let the molten resin material solidify, for example at or above 146° C., the glassy transition temperature Tg of polycarbonate (step S2) Then, in a heating cylinder 12 shown in FIG. 1, heated and melted resin material (e.g. polycarbonate) is ejected from a nozzle 13 at an ejection rate of 100 to 2000 mm/second by moving forward a screw arranged within the heating cylinder 12, and is injected into and fills the cavity 5 via the sprue 6 (step S3).

By heating the fixed die 3 and the movable die 4 in this way to a prescribed temperature high enough not to let the molten resin material solidify, the molten resin material can be prevented from solidifying and can permeate into every corner of the cavity 5 even if the gap S between the fixed die 3 and the movable die 4 is far greater than according to the prior art (the mold aperture). As the gap S between the fixed die 3 and the movable die 4 is sufficiently greater than the length of the fixed punch 4a, the cavity 5 can be filled without obstructing the flow of the molten resin material even if the dies are closed and the resin is ejected with the fixed punch 4a protruding from the outset.

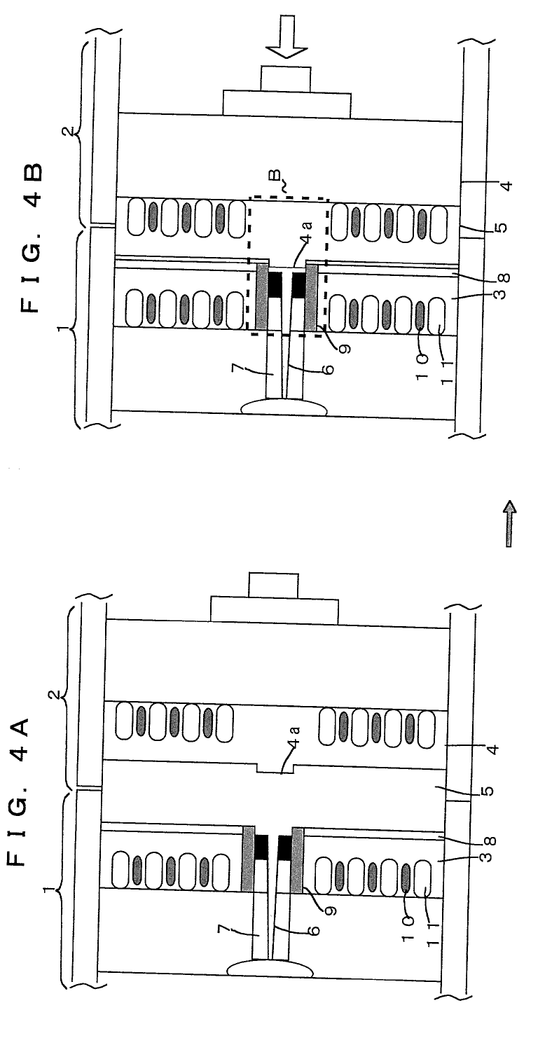

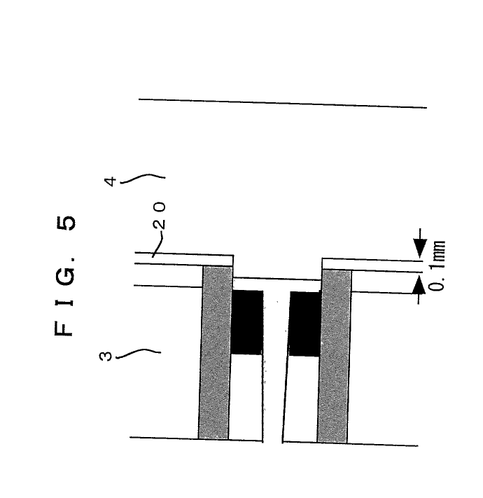

Next, a disk is molded by pressing the molten resin material filling the cavity 5 with the movable die 4, and at the same time the central part of the disk is punched with the fixed punch 4a formed integrally on the mirror plate of the movable die 4 to bore a hole (step S4). FIGS. 4A and 4B show how the disk molding apparatus 100 operates when the molten resin material is pressed with the movable die 4 to mold a disk. FIG. 4A shows the state before the pressing and FIG. 4B, the state after the pressing. Further, an enlarged view of part “B” surrounded by broken lines in FIG. 4B is shown in FIG. 5. As illustrated in FIG. 5, when the molten resin material filling the cavity 5 is pressed to mold a disk 20, substantially at the same time the central part of the disk 20 is punched to bore a hole. The thickness of the disk 20 is about 0.1 mm, far smaller than that of any conventional disk.

Next, the source of power supply of the heaters 10 is turned off, and the fixed die 3 and the movable die 4 are uniformly cooled by the plurality of cooling water channels 11 to a prescribed temperature low enough for the molten resin to solidify, for instance a temperature somewhere between 80° C. and 140° C. (step S5). This causes the disk 20 to be cooled and solidified to produce a disk substrate. Then, the dies are opened by separating the movable side housing 2 from the fixed side housing 1 (step S6), followed by parting of the disk substrate from the stamper 8 on the fixed die 3 by an ejector (step S7). Thus, the disk substrate is manufactured.

As described above, since this embodiment of the invention is so configured that the fixed punch 4a for punching the central part of the disk 20 to bore a hole is formed, integrated with the movable die 4, on the mirror plate of the movable die 4, a drive unit such as a cylinder for sliding only the fixed punch 4a can be dispensed with, resulting in a substantial reduction in the dimensions of the movable side housing 2. This leads to the advantage that the dimensions of the fixed side housing 1 and the movable side housing 2 can be reduced while maintaining the thermal balance between them, and the overall size of the disk molding apparatus can be reduced eventually.

As the reduced size of the movable side housing 2 makes possible a reduction in the hollow part, the rigidity can be increased, and the flexure of the dies can be restrained. Also, the number of die plates can be reduced to enhance dimensional accuracy.

As the fixed punch 4a is formed integrally on the mirror plate of the movable die 4 and does not slide itself, eccentricity, scoring, burrs and contamination can be prevented.

Moreover, as the configuration is such that when the dies are to be closed, a sufficiently wide gap S is allowed between the fixed die 3 and the movable die 4, and the molten resin material, after the cavity 5 is filled with it, is pressed with the movable die 4 to be molded into a disk, whose central part is punched with the fixed punch 4a to bore a hole, an extremely thin disk substrate (e.g. 0.3 mm or less in thickness) can be produced easily and efficiently.

In addition, although this embodiment has a configuration in which the movable side housing 2 provided with the fixed punch 4a is shifted, another configuration is also conceivable in which the movable side housing 2 is fixed, and the fixed side housing 1, with the sprue 6 and other elements built into it, is shifted to press the molten resin material.

Although the embodiment described above uses a horizontal injection molder, similar effects can be achieved with a vertical injection molder as well. Where a vertical injection molder is used, a configuration to be described below as a variation of the above described disk molding apparatus 100 can be adopted.

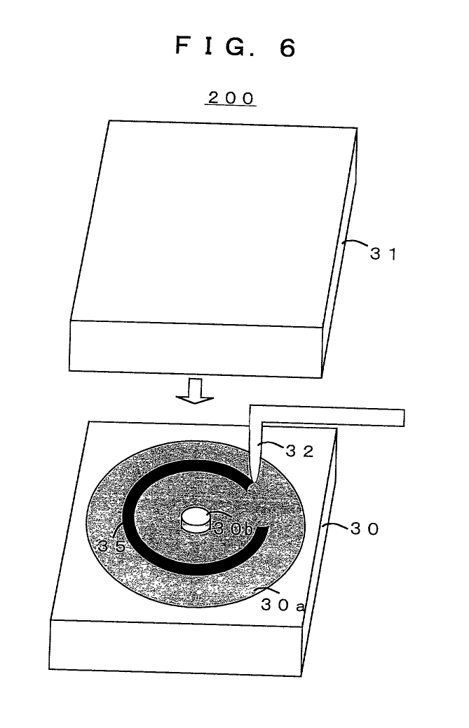

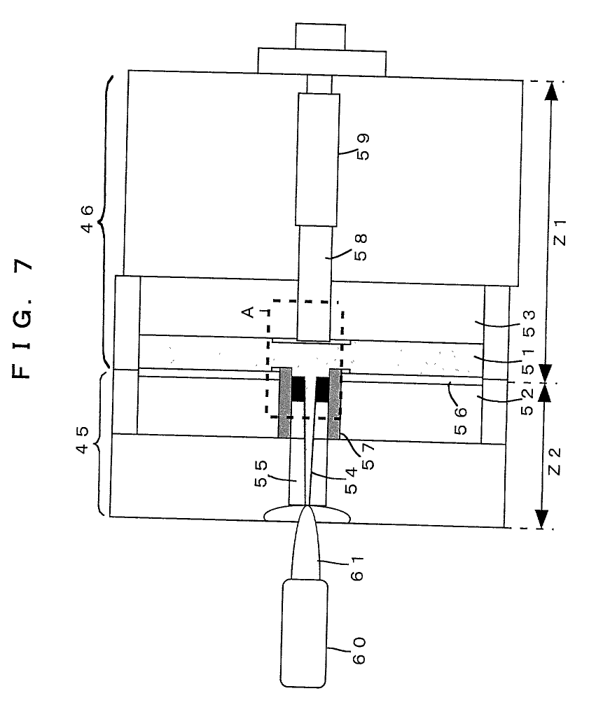

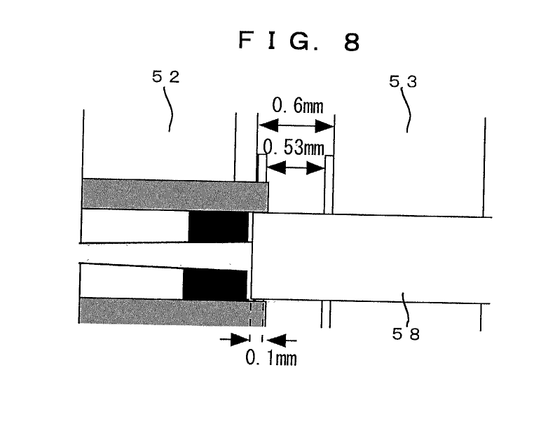

FIG. 6 illustrates another disk molding apparatus of the embodiment than the disk molding apparatus 100. In the illustration of FIG. 6, only the essential part of the disk molding apparatus is shown, but other elements including the movable side housing and the fixed side housing are dispensed with.

In a disk molding apparatus 200 shown in FIG. 6, a fixed punch 30b as a projection for boring a hole in the central part of the disk is provided on the mirror plate 30a of the fixed die 30, formed integrally with the fixed die. Around the fixed punch 30b on the mirror plate 30a of the fixed die 30, there is mounted (arranged) in a doughnut shape molten resin material ejected from a nozzle 32. The molten resin material mounted on the mirror plate 30a (in which a cavity is formed) of the fixed die 30 is pressed with a movable die 31 from above to mold a disk and, as in the disk molding apparatus 100 shown in FIG. 1, a hole is bored with the fixed punch 30b in the central part of the disk. During the period from the ejection of the molten resin material from the nozzle 32 until the pressing by the movable die 31, the fixed die 30 and the movable die 31, as in the disk molding apparatus 100 shown in FIG. 1, are heated with heaters and, after the cavity is filled with the molten resin material, are cooled with cooling water.

This configuration can, in addition to providing the same effects as the disk molding apparatus 100 shown in FIG. 1 does, produce an eccentricity-free disk substrate because it is unaffected by gravity.

The invention may be embodied in other specific forms without departing from the spirit or essential characteristics thereof. The present embodiments are therefore to be considered in all respects as illustrative and not restrictive, the scope of the invention being indicated by the appended claims rather than by the foregoing description and all changes which come within the meaning and range of equivalency of the claims are therefore intended to be embraced therein.

The entire disclosure of Japanese Patent Application No. 2001-176718 filed on Jun. 12, 2001 including the specification, claims, drawings and summary is incorporated herein by reference in its entirety.

What is claimed is:

1. A disk molding apparatus comprising:
a fixed die;
a movable die that presses a molten resin material filling a cavity formed by the fixed die and the movable die to mold a disk and punches a central part of the disk to bore a hole;
a control device that controls a reciprocation of the movable die in a thickness direction of the disk; and
wherein a projection for punching the central part of the disk is formed on a mirror plate of the movable die integrally with the movable die.

2. The disk molding apparatus according to claim 1, wherein a gap between the fixed die and the movable die in a state that dies are closed, is at least greater than length of the projection and great enough to permit the cavity to be filled with the molten resin material.

3. The disk molding apparatus according to claim 1, wherein a gap between the fixed die and the movable die in a state that dies are closed, is not less than 0.1 mm but not more than 5 mm.

4. The disk molding apparatus according to claim 1, wherein length of the projection is greater than thickness of the disk.

5. A disk molding apparatus comprising:
a fixed die;
a movable die that presses a molten resin material mounted on a mirror plate of the fixed die to mold a disk and punches a central part of the disk to bore a hole;
a control device that controls a reciprocation of the movable die in a thickness direction of the disk; and
wherein a projection for boring the hole in the central part of the disk is formed on the mirror plate of the fixed die integrally with the fixed die.

6. The disk molding apparatus according to claim 5, wherein length of the projection is greater than thickness of the disk.

7. A disk substrate manufacturing method comprising:
a process of ejecting a molten resin material into a cavity formed by a fixed die and a movable die; and
a process of molding a disk by pressing the molten resin material filling the cavity, with the movable die, and manufacturing a disk substrate in which a hole is to be bored by punching a central part of the disk with a projection is integrally formed on a mirror plate of the movable die.

8. The disk substrate manufacturing method according to claim 7, wherein during a period from the ejecting the molten resin material into the cavity until the molding the disk by pressing the molten resin material filling the cavity, the fixed die and the movable die are maintained at a prescribed temperature high enough not to let the molten resin material solidify and, after the disk is molded, the fixed die and the movable die are cooled to a prescribed temperature low enough for the molten resin material to solidify.
